(19) United States
(12) Patent Application Publication
(10) Pub. No.: US 2007/0209261 A1
(43) Pub. Date: Sep. 13, 2007

(54) Roller support arrangement for top and bottom display holder

(75) Inventors: Rebecca C. Stover, Lynn, MA (US); David E. Pitcher, Cambridge, MA (US); Thomas P. Burrous, Haverhill, MA (US); Sidney Rose, Marblehead, MA (US); Alan L. Stenfors, Scituate, MA (US)

Correspondence Address: Donald N. Halgren, 35 Central Street, Manchester, MA, 01944, US

(73) Assignee: Rose Displays Ltd.

(21) Appl. No.: 11/320,005

(22) Filed: Dec. 28, 2005

(51) Int. Cl. G09F 7/22

(52) U.S. Cl. 40/617; 40/790

(57) ABSTRACT

A support arrangement for supporting a poster from an adjacent or overhead member. The arrangement comprises an elongated first extruded housing on at least one side of the poster. The housing comprises three chambers defined by opposing sidewalls with a perpendicular connecting bridge and one set of opposing lips. The first and second elongated lips and the lower edge of the sidewalls define an elongated holding third chamber having tapered sidewalls comprising a wedge-shaped elongated chamber. The substrate to be supported may be inserted longitudinally through an elongated space between the tapered sidewalls. A pair of elongated, flexible rollers are arranged within that elongated wedge-shaped holding third chamber. The rollers are of non-linear configuration in at least two planes. The non-linear shape to the rollers ensures contact with the substrate even when the housing is used upside down on the bottom of a substrate. The tapered walls of the wedge-shaped chamber increasingly pinch the rollers together as gravity or another pulling force acts upon the substrate, thus holding the substrate tighter and denying gravity, or any other transverse pulling force, its effect on the substrate and housing.

### BACKGROUND OF THE INVENTION

1. Field of the Invention

This invention relates to multi-chambered extrusions which are to be utilized for rigid support of a display poster or substrate from a ceiling or an overhead support or the like.

2. Prior Art

The prior art cites the use of rollers in a holder arranged at the top of a substrate. The present invention relates to how an assembly is modified to allow the holder to also work on the bottom of the substrate. The key to using rollers with a bottom holder is to ensure their interaction with the substrate. The present invention, from a user's perspective, is passive, the support arrangement functioning similarly on both the top and bottom of the substrate being supported from an overhead or on a wall.

U.S. Pat. No. 6,512,094 to Dilworth relates to a textile hanging system which requires many steps, including opening and closing a banner textile holder over the textile substrate and the pushing end caps on, while holding the textile substrate in place. U.S. Pat. No. 6,003,259 to Krapf et al. relates to a transparent hanger bar for documents. The assembly is difficult because the user must roll strips of acetate and insert them into a hollow chamber. No suggestion is made for use as a bottom holder. U.S. Pat. No. 2,056,878 to Wineholt shows a substrate holder. Two opposing rollers are sprung against one another, working only at the top of a substrate. U.S. Pat. No. 5,711,430 to Anderson et al. relates to a hanger rail assembly. The substrate must be treated to work, and the assembly may only be utilized as a top support. U.S. Pat. No. 3,675,782 to Dudley covers a hanger for sheet material. This device uses rollers which are connected together longitudinally within a space. To remove a supported substrate, one side of the housing must be moved. It will not work as a holder on the bottom of a substrate. U.S. Pat. No. 4,899,974 covers a display clip structure. It may be utilized only as a holder on the top of a substrate.

It is an object of the present invention, to provide a poster gripping assembly which overcomes the disadvantages of the prior art.

It is a further object of the present invention to provide a poster gripping assembly which may be utilized in a poster-holding configuration by itself or with a second assembly for lower support of the poster.

It is a further object of the present invention to provide a poster gripping assembly which simplifies the manufacturing operation over the prior art.

### BRIEF SUMMARY OF THE INVENTION

The present invention relates to an elongated, multi-chambered extrusion support arrangement which is configured to support a large poster substrate from a wall or an overhead support, such as a ceiling rail or the like. The support arrangement of the present invention in a preferred embodiment thereof, comprises an upper elongated multi-chambered housing and a second or lower, elongated multi-chambered housing. The poster substrate is fixedly carried between the upper and the lower elongated housings. The upper housing may be attached to an overhead support such as a ceiling rail by a pair of overhead support lines connected therebetween. The lower end of each overhead support line is attached to a support clip which slidably engages a support clip channel arranged on one elongated side of each of the elongated housings.

Each elongated housing is comprised of an elongated first side wall of generally C-shape in cross-section, facing a second elongated sidewall of generally C-shape in cross-section. The first side wall of the housing has an elongated upper edge which is spaced apart from an elongated upper edge of the second side wall. The first side wall of the housing has an elongated lower edge which is spaced apart from the lower edge of the second side wall of the housing. The first and second side walls are extruded as a unit, with a bridging member connecting the two side walls. The bridging member, together with the first and second side walls, defines an upper first chamber. The first side wall and the second side wall each have a first elongated lip and a second elongated lip respectively, extending from a mid-portion thereof, each facing towards its respective opposed sidewall. The first elongated lip and the second elongated lip are spaced apart from one another so as to provide a narrow elongated gap therebetween. The first elongated lip on the inner side of the first side wall and the second elongated lip on the inner side of the second sidewall define between them and the connecting bridge, a second elongated chamber between the first and second sidewalls, designated as an intermediate chamber. The first elongated lip extending on the inside of the first sidewall and the second elongated lip extending inwardly on the second sidewall together with the lower portions of the lips on the first sidewall and the second sidewall define a lower chamber of the elongated extruded housing.

A pair of elongated, flexible, hollow tubular roller members having a serrated or smooth outer periphery are each rotatably disposed within the lower chamber of the elongated extruded housing. The elongated internally disposed rollers, preferably made of a soft rubber or plastic, have a somewhat curvilinear or helical configuration thereto. The curve of the internal rollers is non-linear in at least two planes, so each roller may not lie in a single plane.

In one preferred embodiment, such non-linear configuration of the internal roller may be established by inserting a helically curved wire or tube fed through the central opening or bore of the flexible roller, so as to impart and transfer that non-linear configuration to the tubular roller.

The “heightwise” dimension of the lower chamber, that is the dimension between the chamber side of the elongated lips, and the lowermost edge adjacent the opening of the first and second sidewalls, is intended to be less than twice the diameter of one of the internal rollers to limit their movement and transverse tolerance.

In utilization of a pair (an upper and a lower housing) of elongated extruded support housings of the present invention, a poster or substrate material is inserted longitudinally through the gap between the lowermost edges of the first sidewall and the second sidewall, so as to pass between the pair of elongated convoluted rollers arranged within the lower chamber of the support arrangement. The preferred invention also includes a similar elongated extruded support housing disposed on and similarly capturing the lowermost side of the poster substrate, so as to act as a stiffener and a lower support keeping that poster or substrate weighted downwardly and flat. The elongated extruded support arrangement may be held to an overhead or ceiling rail by a pair of support clips, slidably arranged in the support clip channel on the upper edge of the uppermost elongated extruded housing. A wire or cable, or any other holding or mounting method of course, may be attached to each support clip and is fixed therefrom to the ceiling rail of a ceiling. Adhesive or other holding means may also be used to mount directly onto a surface such as a wall or window.

Insertion and removal of a poster or substrate from the pair of upper and lower elongated extruded support housings is accomplished by longitudinal movement of that poster substrate relative to the pair of elongated extruded support housings. It is the combination of the round cross-sectional shape of the rollers and the converging angled geometry of the space that prevents removal of a substrate by a force perpendicular to the extrusion on the substrate. The multiple plane nonlinearity of the rollers guarantees their interfering contact with the substrate. The rollers are free to rotate towards the opening, and as they do so rotate, the space (wedge) gets tighter, thus providing an increasingly stronger grip on the substrate.

An end cap is disposed on each end of the elongated extruded housing members. Each end cap has a pair of tabs which extend inwardly into the end openings of the intermediate chamber of the elongated support arrangement so as to hold the end caps snugly thereagainst.

The lowermost elongated chamber in the elongated extruded support arrangement has a pair of opposed facing walls which are tapered inwardly with respect to one another. These walls define a lower side against which each respective internal roller is maintained and pressed. Such tapered walls prevent removal of the substrate and its falling or being pulled transversely out from the elongated housings.

In a further embodiment of the present arrangement, the internal flexible rollers are provided with a multi-dimensional convolution by being slightly longer than the length of the extruded elongated housing in which they are placed. When the end caps are pressed against the ends of the internal rollers once they are inserted within the lower chamber, the end caps will put a compressive force on those pair of internal rollers forcing them to twist/convolute and become nonlinear, ensuring interaction with the substrate to be held.

In yet a further embodiment of the present invention, the elongated extrusion support housings may be curved somewhat, so as to provide a slight curve to the poster or substrate being held between a pair of elongated supports, and also, to eliminate the need for a pre-curved wire or insert within each internal roller. In fact, in such a case, the internal rollers are shorter longitudinally than the arc length of the curved elongated extruded support arrangement.

In yet a further embodiment of the present invention, the internal rollers are supported along their longitudinal length by a separate extrusion which is slidably inserted within and thus fitted in the lowermost chamber of the elongated extruded support housing(s). The additional extrusion is needed if the inner walls of the third chamber in the extruded support housing are not tapered. The elongated insert comprises a lowermost arrangement of opposed tapered walls each having lowermost lips which are spaced apart from one another, to define an elongated opening for a poster or substrate to be inserted therebetween. The tapered walls are spaced apart and define the chamber in which the internal flexible rollers reside. The insert has an elongated uppermost chamber which accepts the edges of the substrate being held by the extrusion arrangement. Such an insert with its tapered lowermost sides, would be available to be inserted into a number of different housing configurations comprised of various shaped elongated extruded support housing outer sidewalls. These sidewalls may be flat with rigid right angles to define their uppermost and lowermost edges, or they may be curved in an opposed C-shaped configuration, or they may have any desired decorative shape. Each of those shell-like arrangements have the bridging connector and the first side lip and the second side lip as identified hereinabove, which would thus define a space in the elongated housing into which the separate elongated roller-containing extrusion would be placed in the absence of the tapered walls of the third chamber.

Thus the present invention shows a hollow, elongated extruded poster grasping housing which is capable of lockably supporting a large poster or substrate, also having a lowermost housing extrusion to support and hang down upon the lower edge of that poster or substrate therebetween. The rollers arranged within each elongated extrusion are dimensioned such that they do not pass over each other and that, arranged into a pair of interacting convolutions, must interfere with the space in line with the center slot arranged between the sidewalls of the elongated support housing(s). This interference prevents the poster or substrate from becoming loose from each elongated support housing when it is pulled upon or set in place, thereby denying gravity its affects on that substrate.

The invention thus comprises a support arrangement for supporting a poster from an overhead member, comprising: an elongated first extruded housing having an elongated first side wall and an elongated second side wall. Each of the first and second side walls have an upper edge and a lower edge spaced apart from each other. A bridging member is spaced between and connecting the first and the second sidewalls. The bridging member and the upper edge of the sidewalls define an elongated first chamber. A first and a second elongated lip extend along an inner side of the first and second sidewalls respectively, the first and second lips and the bridging member define an elongated intermediate second chamber. The first and second elongated lips and the lower edge of the sidewalls define an elongated holding third chamber. A pair of elongated, flexible rollers are arranged within the elongated holding third chamber. The rollers are preferably non-linear in two planes. The rollers may have an irregular outer surface. The rollers may be hollow. At least one of said rollers may have a bendable wire arranged therethrough. The wire may be arranged in at least one roller in a generally non-linear configuration. The rollers may be arranged in an insert disposed in the lower chamber in the housing. The third chamber preferably has tapered walls to support the rollers therein. The third chamber has a longitudinal slot defining one edge thereof. The poster is preferably received through the elongated slot in the third chamber. The elongated housing preferably has end caps on each end thereof. The elongated housing may be curved. The rollers in one embodiment may be shorter than the elongated housing. The rollers may be longer than the elongated housing in another embodiment. Two end caps may be utilized to compress the rollers into being oriented non-linearly in two planes within the third chamber. A second elongated housing may be utilized to engagably receive a second edge of the poster parallel to the first elongated housing.

The invention also includes a method for supporting a poster from an overhead support, comprising one or more of the steps of: receiving a poster within a lower chamber through a slot of an elongated first housing; attaching a support arrangement between the elongated first housing and the overhead support; and pinching the poster within the lower chamber of the first housing between a pair of convoluted flexible rollers to keep the poster from falling out from the housing. The method may include one or more of the following steps: inserting a twisted wire into the rollers to effect the convolution of the rollers; placing the rollers into the lower chamber, the rollers having a longer length than the elongated housing; placing end caps on the housing to longitudinally compress and distort the rollers into the convoluted shape; curving the elongated housing along its longitudinal axis; placing the rollers in an elongated insert; placing the insert into the lower chamber of the housing; and attaching a second elongated housing to a second edge of the poster being supported.

### BRIEF DESCRIPTION OF THE DRAWINGS

The objects and advantages of the present invention would become more apparent when viewed in conjunction with the following drawings, in which:

FIG. 1 is a perspective view of a pair of elongated extruded support arrangements carrying a poster substrate therebetween, these support arrangements being attached to an overhead support by a pair of support lines;

FIG. 2 is a sectional view taken along the line 2-2 of FIG. 1;

FIG. 3 is a perspective view similar to that shown in FIG. 1, showing a poster or substrate in a removed or inserted configuration between an upper or lower elongated extruded support;

FIG. 4 is an exploded perspective view of an elongated extruded substrate with a pair of internal rollers arranged therein and extending slightly therefrom or at one end thereof with an end cap ready for insertion thereagainst;

FIG. 5 is a perspective view of an elongated extruded support arrangement of the present invention, with an end cap spaced therefrom, the elongated support arrangement having a curve thereto;

FIG. 6 is a planned view of an internal roller of the present invention, having a convoluted shape and a wire extending therefrom;

FIGS. 7A and 7B and 7C are end views of the extruded elongated support arrangements having curved sides thereat;

FIGS. 8A, 8B and 8C are end views of the elongated support arrangement and a square cross section; and

FIG. 9 is a cross sectional view of an insert with a pair of internal rollers and a portion of a poster substrate shown, which insert is adaptable for use within a shell shown in FIGS. 7A, 7B, 8A, and 8B.

### DESCRIPTION OF THE PREFERRED EMBODIMENTS

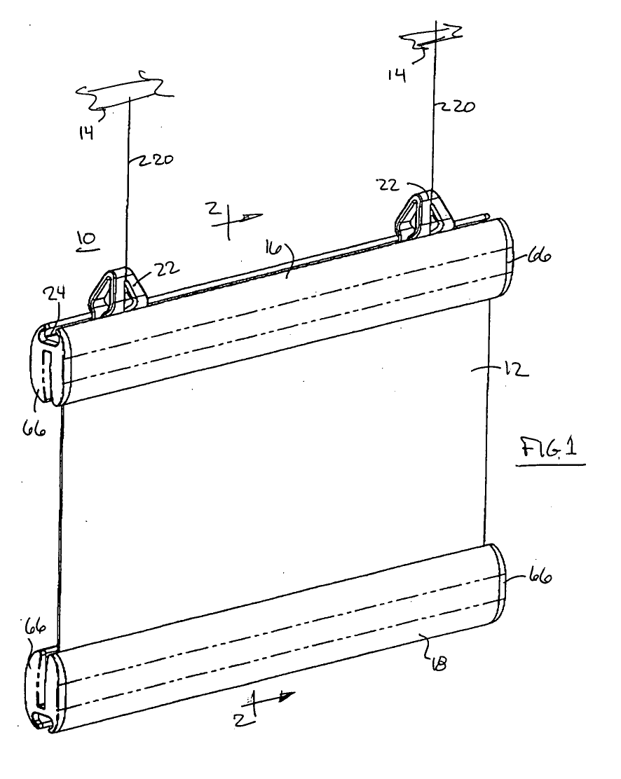

Referring now to the drawings in detail, and particularly to FIG. 1, there is shown the present invention which comprises an elongated, multi-chambered extrusion support arrangement 10 which is configured to support a large poster substrate 12 from an overhead support, such as a ceiling rail 14 or the like. The support arrangement 10 of the present invention in a preferred embodiment thereof, comprises an upper, elongated, extruded, multi-chambered housing 16 and a second or lower, elongated multi-chambered housing 18. The poster substrate 12 is fixedly carried between the upper and the lower elongated housings 16 and 18. The upper housing 16 may be attached to the overhead support ceiling rail 14 by a pair of overhead support lines 20 connected therebetween. The lower end of each overhead support line 20 is attached to a support clip 22 which slidably engages a support clip channel 24 arranged on one elongated side of each of the elongated housings 16 and 18, as shown in FIGS. 1 and 2.

Each elongated housing 16 and 18 is comprised of an elongated first side wall 26 of generally C-shape in cross-section, facing a second elongated sidewall 28 of generally C-shape in cross-section, as represented in FIG. 2. The first side wall 26 of the housing 16 or 18 has an elongated upper edge 30 which is spaced apart from an elongated upper edge 32 of the second side wall 28. The first side wall 26 of the housing 16 or 18 has an elongated lower edge 34 which is spaced apart from the lower edge 36 of the second side wall 28 of the housing 16 or 18. The first and second side walls 26 and 28 are co-extruded with one another and with a bridging member 40 connecting the two side walls 26 and 28. The bridging member 40 is formed part-way up a central portion of the transverse height of the elongated extruded housing 16 or 18. The first side wall 26 and the second side wall 28 each have a first elongated lip 42 and a second elongated lip 44 respectively, extending from a mid-portion thereof as best seen in FIG. 2, each lip 42 and 44 facing towards its respective opposed sidewall 28 and 26. The first elongated lip 42 and the second elongated lip 44 are spaced apart from one another so as to provide a narrow elongated gap 46 therebetween. The first elongated lip 42 on the inner side of the first side wall 26 and the second elongated lip 44 on the inner side of the second sidewall 28 define between them and the connecting bridge 40, a middle or intermediate elongated chamber 48 between the first and second sidewalls 26 and 28. The first elongated lip 42 extending on the inside of the first sidewall 26 and the second elongated lip 44 extending inwardly on the second sidewall 28 together with the lower portions of the lips 34 and 36 on the first sidewall 26 and the second sidewall 28 define a lower holding or third chamber 50 of the elongated extruded housing 16 or 18.

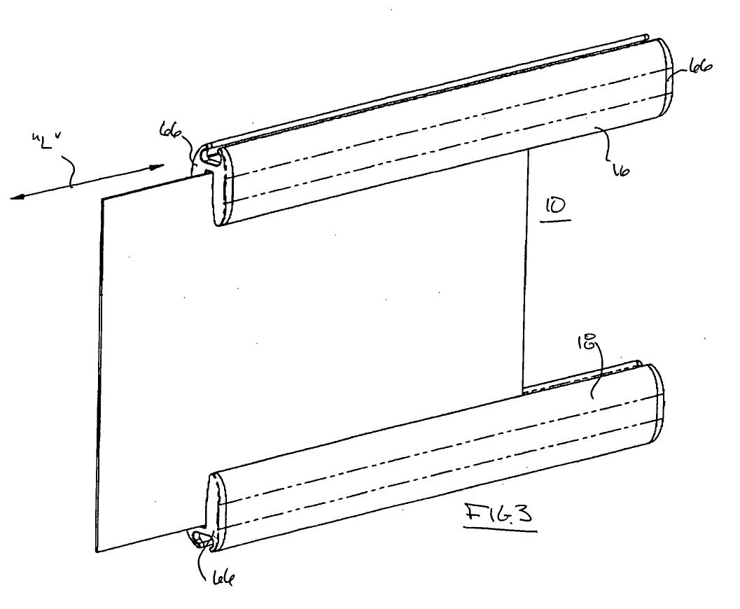

A pair of elongated, flexible, hollow tubular roller members 52 having a serrated (or smooth) outer periphery 54 are each somewhat rotatably disposed within the lower chamber 50 of the elongated extruded housings 16 and 18. The elongated internally disposed rollers 52, are preferably made of a soft rubber or plastic, have a somewhat curvilinear configuration, a configuration being spiral or non-linear in multiple planes, as is represented in FIG. 6. The curve of the internal rollers, being non-linear in multiple planes, ensures each roller is in contact with the substrate 12.

In one preferred embodiment, such non-linear configuration of the internal roller 52 may be established by inserting a curved wire or tube 56 fed through the central opening or bore 58 of the flexible roller 52, so as to impart that non-linear configuration thereto, as represented in FIG. 6.

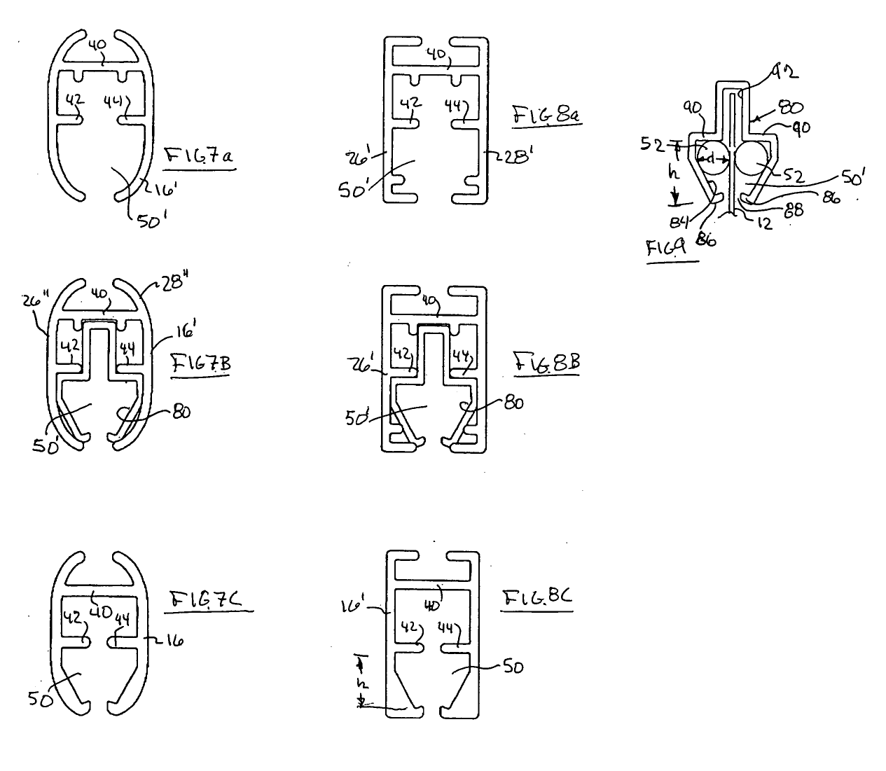

The “heightwise” dimension “H” of the lower chamber 50, as represented in FIGS. 2 and 8C, that is the dimension between the chamber side of the elongated lips 42 and 44, and the lowermost edge 34 and 36 adjacent the opening 60 of the first and second sidewalls 26 and 28, is intended to be less than twice the diameter of one of the internal rollers 52 to limit their movement transversely and prevent the rollers 52 from crossing over each other within the lowermost chamber 50.

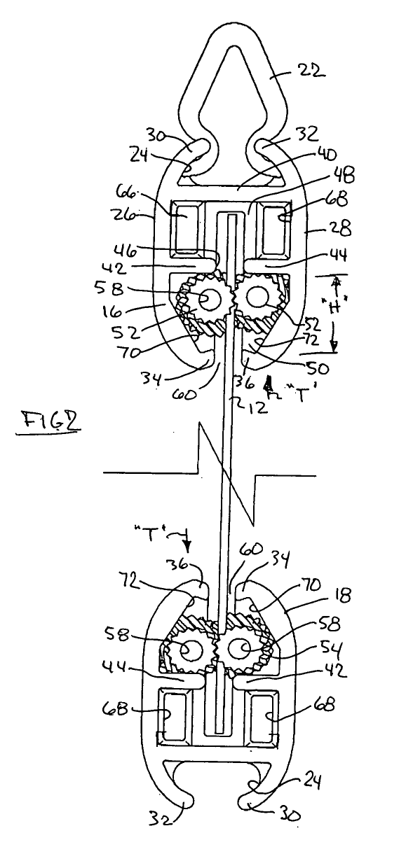

In utilization of a pair (an upper and a lower housing) of elongated extruded support housings 16 and 18, (as represented in FIGS. 1, 2 and 3), of the present invention, a poster or substrate material 12 may be inserted longitudinally, as represented by arrow “L” in FIG. 3 through the gap 60 between the lowermost edges 34 and 36 of the first sidewall 26 and the second sidewall 28, so as to pass between the pair of spaced apart elongated non-linear or “convoluted” rollers 52 and 52 arranged within the lower chamber 50 of the support housing 16 and 18. The preferred inventive arrangement 10 includes the similar elongated extruded support housing 18 disposed on and similarly capturing the lowermost side of the poster substrate 12, as represented in FIGS. 1, 2 and 3, so as to act as a stiffener and a lower support or weight, thus keeping that poster or substrate 12 being weighted downwardly and flat. The elongated extruded support housing arrangement 10 may be held/adhered to any overhead member or ceiling rail 14, by for example, the pair of support clips 22 and 22, slidably arranged in the support clip channel 24 on the upper edge of the uppermost elongated extruded housing 16. The wire or cable 20, or any other hanging or mounting means of course, is attached to each support clip 22 and is fixed therefrom preferably to the ceiling rail 14 of a ceiling.

Insertion and/or removal of a poster or substrate 12 from the pair of upper and lower elongated extruded support housings 16 and 18 may be accomplished by longitudinal movement of that poster substrate 12 relative to the pair of elongated extruded support housings 16 and 18, as represented by arrow “L” shown in FIG. 3. The non-linear nature of the pair of internal rollers 52 disposed on each side of the poster substrate 12, as represented in FIG. 2, and the wedged-shaped geometry of the elongated third chamber 50 (or insert 80) in which they reside, allows their slight rotation with respect to one another on a downward pull of the poster substrate 12, and with this rotation forces the rollers 52 closer together to provide a tighter grip on the substrate 12, and thus prevent any further large unintended transverse movement of that poster or substrate 12.

An end cap 66 is disposed on each end of the elongated extruded housing member 16 and 18. Each end cap 66 has a pair of tabs 68, as shown in FIGS. 2, 4 and 5, which extend inwardly into the respective end openings of the intermediate chamber 48 of the elongated support housing 16 and 18 so as to hold the end caps 66 snugly thereagainst.

The lowermost elongated chamber 50 in each elongated extruded support housing 16 and 18, in one preferred embodiment, has a pair of opposed facing walls 70 and 72 which are tapered inwardly with respect to one another. These walls 70 and 72 define a lower side against which each respective internal roller 52 is maintained and pressed. Such tapered walls 70 and 72 allow each roller 52 to rotate slightly and provide a tighter grip when the substrate is pulled transversely away from the elongated extrusion 16 or 18.

In a further embodiment of the present arrangement, the internal flexible rollers 52 are provided with their multi-dimensional twist or convolution thereto, by being slightly longer than the length of the extruded elongated housing 16 in which they are placed, as represented in FIG. 4. When the end caps 66 are pressed against the ends of the internal rollers 52, once the rollers 52 are inserted within the lower chamber 50, the end caps 66 will put a compressive force on those pair of internal rollers 52 and 52, forcing them to convolute, distort in three dimensions, and thus come into contact with a substrate when it enters the lower chamber 50.

In yet a further embodiment of the present invention, the elongated extrusion support housings 16 and 18 may be curved somewhat, along its longitudinal axis “X”, as represented in FIG. 5, so as to provide a slight curve to a poster or substrate 12 being supported between a pair of elongated support housings 16 and 18, and also, to eliminate the need for a pre-curved wire or insert within each internal roller 52. In fact, in such a case, the internal rollers 52, may be shorter longitudinally, than the arc length of the curved elongated extruded support housing 16 and 18, to minimize manufacturing tolerance concerns.

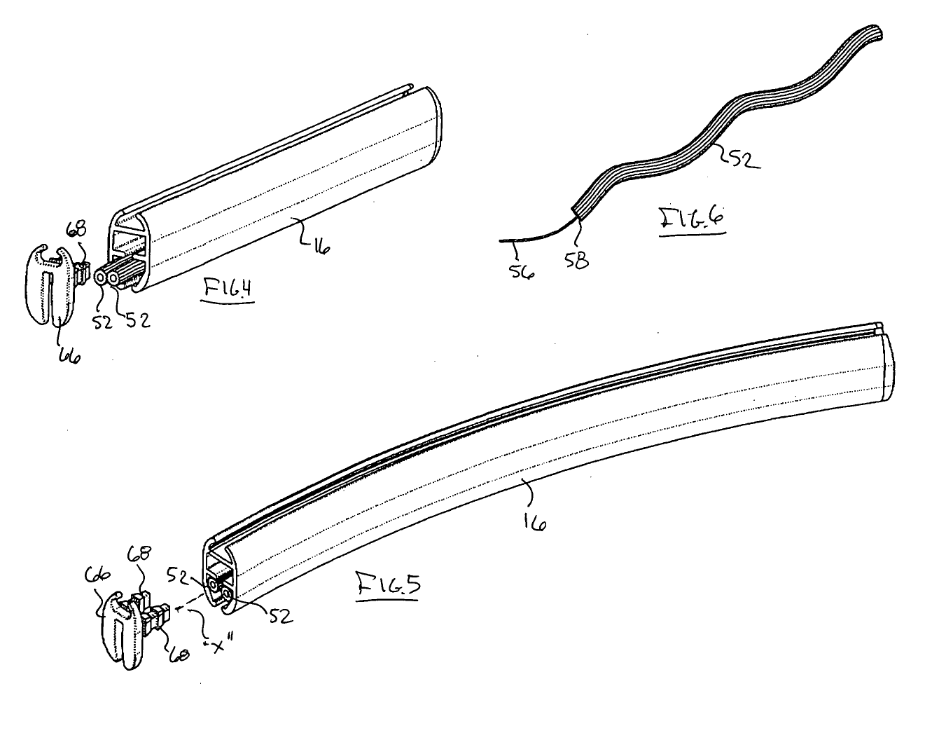

In yet a further embodiment of the present invention, the internal rollers 52 are supported along their longitudinal length by an extruded, hollow insert 80 as represented in FIG. 9. The insert 80 is slidably inserted within and thus fitted in the lowermost chamber 50′ of one or both of the elongated extruded support housing(s) 16 and 18, as represented in FIGS. 7a, 7b, 8a and 8b. The elongated insert 80 comprises a lowermost arrangement of opposed tapered walls 82 and 84 each having lowermost lips 86 which are spaced apart from one another, to define an elongated opening 88 for a poster or substrate 12 to be inserted therebetween. The tapered walls 82 and 84 are spaced apart and define the chamber 50′ in which the internal flexible rollers 52 reside. The insert 80 has a second or upper wall 90 which defines the upper side of the chamber 50′ in which the elongated internal rollers 52 reside. An elongated uppermost chamber 92 is also arranged therein, in which the uppermost or lowermost edge of a poster or substrate 12 would be placed when engaged within the upper or the lower extruded elongated support housing 16 or 18. Such an insert 80 with its tapered lowermost sides 82 and 84, would be available to be inserted into a number of different housing configurations comprised of various shaped elongated extruded support housing sidewalls, as represented in FIGS. 7A and 8A. These sidewalls 26′ and 28′ may be flat with rigid right angles, as shown in FIGS. 8a, 8b and 8c, to define their uppermost and lowermost edges or they may be curved sidewalls 26″ and 28″, as shown in FIGS. 7a, 7b and 7c, in an opposed C-shaped configuration, or any other decorative shape desired. Each of those shell-like arrangements have the bridging connector 40 and the first side lip 42 and the second side lip 44 as identified in other embodiments hereinabove, which would thus define a space 50′ in the elongated housing. In FIGS. 7a, 7b, 8a and 8b, the elongated roller-containing insert 80 would be placed into space 50′.

Thus the present invention shows a hollow, elongated extruded, poster grasping housing which is capable of lockably supporting a large poster or substrate, also having a lowermost housing extrusion to support and hang down upon the lower edge of that poster or substrate therebetween. The rollers arranged within each elongated extrusion are dimensioned such that they do not pass over each other and that, arranged into a pair of interacting convolutions, must interfere with the space in line with the center slot arranged between the sidewalls of the elongated support housing(s). This interference ensures contact with the substrate, thus preventing the poster or substrate from becoming loose from one or each elongated support housing when it is pulled upon or set in place, thereby denying gravity its affect on that substrate.

We claim:

1. A support arrangement for supporting a poster from an adjacent member, comprising:
an elongated first extruded housing having an elongated first side wall and an elongated second side wall; each of said first and second side walls having an upper edge and a lower edge;
a bridging member spaced between and connecting said first and said second sidewalls, said bridging member and said upper edge of said sidewalls defining an elongated first chamber;
a first and a second elongated lip extending along an inner side of said first and second sidewalls respectively, said first and second lips and said bridging member defining an elongated intermediate second chamber;
said first and second elongated lips and said lower edge of said sidewalls defining an elongated holding third chamber having tapered side walls; and
a pair of elongated, flexible rollers arranged within said tapered side walls of said elongated holding third chamber.

2. The support arrangement as recited in claim 1, wherein said rollers are of non-linear configuration in at least two planes.

3. The support arrangement as recited in claim 1, wherein said rollers have an irregular outer surface.

4. The support arrangement as recited in claim 1, wherein said rollers are hollow.

5. The support arrangement as recited in claim 4, wherein at least one of said rollers has a bendable wire arranged therethrough.

6. The support arrangement as recited in claim 5, wherein said wire is arranged in at least one of said rollers in a configuration generally non-linear in an at least two planes.

7. The support arrangement as recited in claim 1, wherein said rollers are arranged in an insert disposed in said lower chamber in said housing.

8. The support arrangement as recited in claim 1, wherein said third chamber has tapered sidewalls walls to wedgingly support said rollers therein.

9. The support arrangement as recited in claim 1, wherein said third chamber has a longitudinal slot defining one edge thereof.

10. The support arrangement as recited in claim 9, wherein said poster is received through said slot in said third chamber.

11. The support arrangement as recited in claim 1, wherein said elongated housing has an end cap on each end thereof.

12. The support arrangement as recited in claim 1, wherein said elongated housing is curved.

13. The support arrangement as recited in claim 12, wherein said rollers are shorter than said elongated housing.

14. The support arrangement as recited in claim 11, wherein said rollers are longer than said elongated housing.

15. The support arrangement as recited in claim 14, wherein said end caps compress said rollers into a non-linear orientation of at least two planes, within said third chamber.

16. The support arrangement as recited in claim 1, including a second elongated housing for engagably receiving a second edge of said poster parallel to said first elongated housing.

17. The support arrangement as recited in claim 1, wherein said tapered walls of said third chamber is comprised of an insert disposed therein.

18. A method for supporting a poster from an adjacent member, comprising:
receiving a poster within a lower chamber through a slot of an elongated first housing;
attaching a support arrangement between said elongated first housing and said adjacent support member; and
pinching said poster within said lower chamber of said first housing between a pair of convoluted flexible rollers to keep said poster from falling out from said housing.

19. The method as recited in claim 18, including:
inserting a twisted wire into said rollers to effect said convolution of said rollers into at least two planes.

20. The method as recited in claim 18, including:
placing said rollers into said lower chamber, said rollers having a longer length than said elongated housing;
placing an end cap on each end of said housing to longitudinally compress and distort said rollers into said convoluted shape of said rollers.

21. The method as recited in claim 18, including:
curving said elongated housing along its longitudinal axis.

22. The method as recited in claim 18, including:
placing said rollers in an elongated insert; and
placing said insert into said lower chamber of said housing.

23. The method as recited in claim 18, including:
attaching a second elongated housing to a second edge of said poster being supported.
